(19) United States
(12) Patent Application Publication
(10) Pub. No.: US 2009/0253011 A1
(43) Pub. Date: Oct. 8, 2009

(54) Fuel Cell

(76) Inventor: Yasuo Kuwabara, Aichi-ken (JP)

Correspondence Address: KENYON & KENYON LLP, 1500 K STREET N.W., SUITE 700, WASHINGTON, DC, 20005, US

(21) Appl. No.: 11/992,124

(22) PCT Filed: Sep. 19, 2006
(86) PCT No.: PCT/JP2006/318898

§ 371 Date: Mar. 17, 2008

(30) Foreign Application Priority Data
Sep. 20, 2005 (JP) 2005 271448

(51) Int. Cl. H01M 8/10

(52) U.S. Cl. 429/30

(57) ABSTRACT

A fuel cell that includes an anode-side diffusion layer, an anode-side catalyst layer, an electrolyte membrane, a cathode-side catalyst and a cathode-side diffusion layer layered in that order. The anode-side catalyst layer includes Pt—Ru catalyst. A catalyst layer portion of the anode-side catalyst layer apart from the electrolyte membrane and/or the anode-side diffusion layer contains a metal element which is lower in standard potential than Ru and higher in standard potential than hydrogen. The metal element which is lower in standard potential than Ru and higher in standard potential than hydrogen is at least one element which may be selected from, for example, Cu, Re and Ge. By this structure, both prevention of poisoning of Pt—Ru catalyst by CO and prevention of contamination of an electrolyte membrane can be satisfied.

### TECHNICAL FIELD

The present invention relates to a fuel cell which can satisfy both prevention of poisoning of Pt—Ru catalyst by CO and prevention of contamination of an electrolyte membrane.

### BACKGROUND

Conventionally, a polymer electrolyte fuel cell is constructed by constructing a membrane-electrode assembly (MEA) by forming an anode at one surface of an electrolyte membrane and a cathode at the other surface of the electrolyte membrane. The membrane-electrode assembly (MEA) is then sandwiched by separators. When supplying fuel gas, including hydrogen to the anode and oxidant gas including oxygen to the cathode, the hydrogen changes to hydrogen ions (i.e. protons) and electrons at the anode. Then, the hydrogen ions move through the electrolyte membrane to the cathode where the hydrogen ions react with oxygen supplied and electrons (which are generated at an anode of the adjacent MEA and move to the cathode of the instant MEA through a separator, or which are generated at an anode of a fuel cell located at a first end of a fuel cell stack and move to a cathode of a fuel cell located at a second, opposite end of the fuel cell stack through an external electrical circuit) to form water, thereby generating power.

For the electrolyte, an ion-exchange membrane, including a sulfonic acid group which has proton transmitting ability, may be used.

When hydrogen obtained by steam-reforming methane, methanol or natural gas is used for the fuel gas of the fuel cell, the reformed gas contains CO. The CO poisons Pt (platinum), which is a catalyst component of the anode (i.e., makes a CO layer around PT and the CO layer prevents hydrogen from contacting Pt), thereby decreasing the fuel cell performance. It is known that, as illustrated in FIG. 8, Ru (ruthenium) is added to the catalyst and the catalyst may be changed in the form of Pt—Ru alloy 1 and carried on the carrier 2. The catalyst may be effective to suppress poisoning of Pt by CO (because Ru operates to change CO to CO₂).

However, because Ru is lower in electrochemical standard potential than Pt, when the anode potential rises near the Ru standard potential due to an excessively high voltage of the fuel cell, the Ru changes to Ru²⁺ ions and melts out. As a result, the amount of Ru decreases and the effect changing the catalyst to the form of Pt—Ru alloy (suppression of CO-poisoning of Pt) also decreases.

Japanese Patent Publication 2001-76742 proposes to cause an anode catalyst layer to contain Re (rhenium) in order to suppress CO-poisoning of Pt—Ru catalyst of the anode. Since Re is lower in electrochemical standard potential than Ru, when the anode potential rises, Re begins to melt earlier than Ru so that Re operates as a sacrificial anode to suppress melting of Ru.

When Re melts out and Re ions (positive ions) diffuse to the electrolyte membrane, the Re ions chemically react with the sulfonic acid group of the ion-exchange membrane to deteriorate the proton transmitting ability of the sulfonic acid group, thereby deteriorating the proton transmitting ability of the electrolyte membrane and decreasing the fuel cell performance. In other words, when the anode catalyst layer contains Re (rhenium), it can be difficult to satisfy both suppression of CO-poisoning of the Pt—Ru catalyst and suppression of contamination of the electrolyte membrane. This is a problem that may be addressed by certain embodiments of the present invention.

### BRIEF SUMMARY

An object of the present invention is to provide a fuel cell which can satisfy both suppression of CO-poisoning of a Pt—Ru catalyst and suppression of contamination of an electrolyte membrane.

A fuel cell according to certain embodiments of the present invention, that may address the above-described problem and perform the above-described object, can include an anode-side diffusion layer, an anode-side catalyst layer, an electrolyte membrane, a cathode-side catalyst, and a cathode-side diffusion layer layered in that order. In the fuel cell, the anode-side catalyst layer can include a Pt—Ru catalyst, and a catalyst layer portion of the anode-side catalyst layer apart from the electrolyte membrane and/or the anode-side diffusion layer can contain a metal element which is lower in standard potential than Ru and higher in standard potential than hydrogen.

Preferably, the metal element is a metal element which is lower than 0.46V and higher than 0.10V in standard potential.

Preferably, the metal element is a metal element which is lower than 0.46V and higher than 0.20V in standard potential.

Preferably, the metal element which is lower in standard potential than Ru and higher in standard potential than hydrogen is at least one element selected from the group composed of Cu, Re and Ge.

Preferably, the metal element which is lower in standard potential than Ru and higher in standard potential than hydrogen is Cu.

The metal element may be mixed in the anode-side catalyst layer and/or the anode-side diffusion layer.

The metal element may be carried by a carbon particle or a carbon fiber of the anode-side diffusion layer and/or a catalyst carrier of the anode-side catalyst layer.

A part of the fuel cell where the metal element is contained can be any one of the following first to third cases:

In the first case, the metal element is contained in the anode-side diffusion layer only and is not contained in the anode-side catalyst layer.

In the second case, the anode-side catalyst layer is a single layer and the metal element is contained in the catalyst layer portion of the anode-side catalyst layer apart from the electrolyte membrane.

In the third case, the anode-side catalyst layer is a double layer and the metal element is included in a layer of the double anode-side catalyst layer apart from the electrolyte membrane.

The metal element is not contained in the cathode-side catalyst layer and in the cathode-side diffusion layer.

The metal element electrically conducts to the Ru via carbon of the anode-side diffusion layer (13) and/or of the anode-side catalyst layer.

According to a fuel cell of other embodiments of the present invention, since the metal element, which is lower in standard potential than Ru and higher in standard potential than hydrogen is provided, the metal element melts out earlier than Ru to suppress melting of Ru so that suppression of CO-poisoning of Pt by Ru is maintained. Further, since the metal element which is lower in standard potential than Ru and higher in standard potential than hydrogen is contained at the catalyst layer portion of the anode-side catalyst layer apart from the electrolyte membrane and/or the anode-side diffusion layer, when the metal element melts out in the form of ions, the metal element ions is unlikely to arrive at the electrolyte membrane and is unlikely to deteriorate the proton transmitting ability of the electrolyte membrane. As a result, both suppression of CO-poisoning of a Pt—Ru catalyst and suppression of contamination of an electrolyte membrane can be satisfied.

For an example of the metal element which is lower in standard potential than Ru and higher in standard potential than hydrogen, Cu, Re, or Ge can be utilized.

The invention may be embodied by numerous other devices and methods. The description provided herein, when taken in conjunction with the annexed drawings, discloses examples of the invention. Other embodiments, which incorporate some or all steps as taught herein, are also possible.

### BRIEF DESCRIPTION OF THE DRAWINGS

Referring to the drawings, which form a part of this disclosure:

FIG. 1 is a cross-sectional view of a portion of an MEA and a diffusion layer of a fuel cell according to Embodiment 1 of the present invention;

FIG. 2 is a cross-sectional view of a portion of an MEA and a diffusion layer of a fuel cell according to Embodiments 2 and 3 of the present invention, where a catalyst layer is divided into a layer contacting an electrolyte membrane and a layer apart from the electrolyte membrane and the two layers are layered;

FIG. 3 is an enlarged cross-sectional view of a catalyst, a catalyst carrier, and the metal element mixed, in the catalyst layer according to Embodiment 2 of the present invention;

FIG. 4 is an enlarged cross-sectional view of a catalyst, a catalyst carrier, and the metal element mixed, in the catalyst layer according to Embodiment 3 of the present invention;

FIG. 5 is a side-elevational view of a stack of the fuel cells according to the present invention;

FIG. 6 is a cross-sectional view of a portion of the stack of the fuel cells according to the present invention;

FIG. 7 is a front-elevational view of the fuel cell according to the present invention; and

FIG. 8 is an enlarged cross-sectional view of a catalyst and a catalyst carrier in a catalyst layer of a conventional fuel cell.

### DETAILED DESCRIPTION

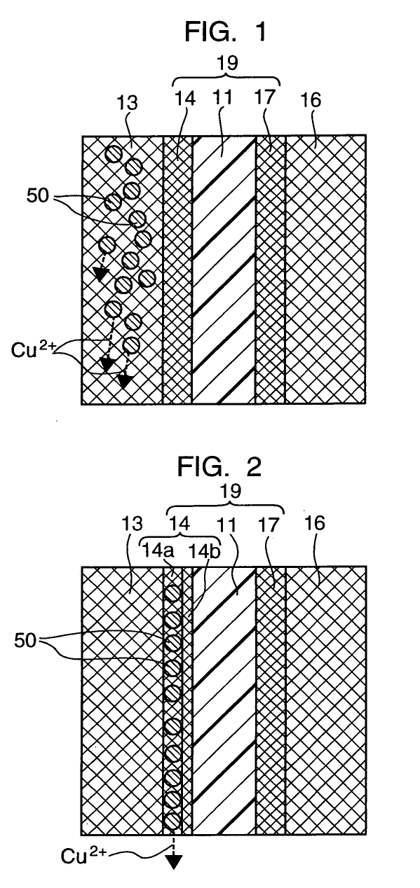

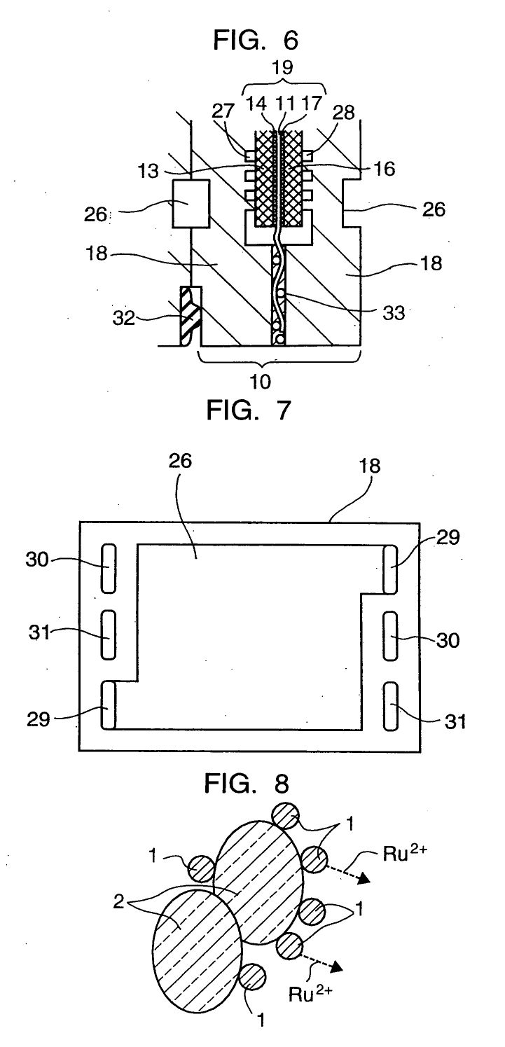

A fuel cell according to certain embodiments of the present invention will be explained with reference to FIGS. 1-7.

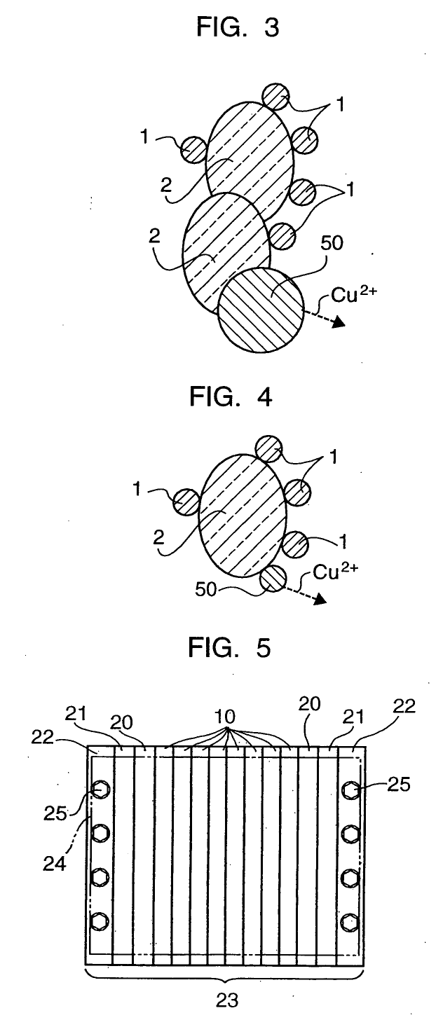

FIG. 1 illustrates Embodiment 1 of the present invention; FIGS. 2 and 3 illustrate Embodiment 2 of the present invention; and FIGS. 2 and 4 illustrate Embodiment 3 of the present invention. FIGS. 5-7 are applicable to all Embodiments of the present invention. Structural portions common to all embodiments of the present invention are denoted with the same reference numerals throughout all embodiments of the present invention.

First, portions common to all embodiments of the present invention and technical advantages thereof will be explained with reference to FIGS. 5-7.

A fuel cell 10 according to the present invention is, for example, a polymer electrolyte fuel cell. The fuel cell 10 is a fuel cell non-movable and used in home or a fuel cell used for a vehicle.

The polymer electrolyte fuel cell (fuel cell) 10 includes a layered structure of a membrane-electrode assembly (MEA) 19 and a separator 18.

The MEA 19 includes an electrolyte membrane 11 made from an ion exchange membrane, a first electrode (an anode, a fuel electrode) 14 disposed at a first surface of the electrolyte membrane 11 and including a first catalyst layer, and a second electrode (a cathode, an air electrode) 17 disposed at a second, opposite surface of the electrolyte membrane 11 and including a second catalyst layer. A first diffusion layer 13 is disposed between the anode of the MEA and the separator 18, and a second diffusion layer 16 is disposed between the cathode of the MEA and the separator 18.

A fuel cell module is constructed by layering the MEA 19 and the separators 18 (and in a case of one fuel cell module, the fuel cell module is the same as the fuel cell). A stack of fuel cells is constructed by layering fuel cell modules. A fuel cell stack 23 is constructed by disposing a terminal 20, an insulator 21 and an end plate 22 at each of opposite ends of the stack of fuel cells and fixing the opposite end plates 22 to a fastening member (for example, a tension plate 24) by a bolt and a nut 25. A fastening load operating in a fuel cell layering direction is imposed to the stack of fuel cells by an adjusting screw disposed at one end plate 22 located at one end of the stack of fuel cells via a spring disposed between the adjusting screw and the stack of fuel cells.

The separator 18 is made from any one of a carbon separator, a metal separator, a resin separator containing a conductive material, and a combination of a metal separator and a resin frame.

At a power generating region, a fuel gas passage 27 for supplying fuel gas (including hydrogen) to the anode 14 is formed in the separator 18, and an oxidant gas passage 28 for supplying oxidant gas (including oxygen, usually, air) is formed in the separator 18. The fuel gas can be reformed gas including hydrogen obtained by steam-reforming methane, methanol or natural gas. In the case of reformed gas, CO is contained in the reformed gas. Further, a coolant passage 26 is also formed in the separator 18 for flowing coolant (usually, water). At a non-power generating region, a fuel gas manifold 30, an oxidant gas manifold 31 and a coolant manifold 29 are formed in the separator 18. The fuel gas manifold 30 communicates with the fuel gas passage 27, and the oxidant gas manifold 31 communicates with the oxidant gas passage 28. The coolant manifold 29 communicates with the coolant passage 26.

The fuel gas, the oxidant gas and the coolant are sealed from each other in the fuel cell. A first seal member (for example, an adhesive) 33 seals a clearance between the two separators sandwiching the MEA of each fuel cell module, and a second seal member (for example, a gasket) 32 seals a clearance between adjacent fuel cell modules. The first member 33 may be made from a gasket, and the second seal member 32 may be made from an adhesive.

At the anode 14 of each fuel cell 10, ionization reaction for changing hydrogen to hydrogen ions (i.e. protons) and electrons is conducted. Then, the hydrogen ions move through electrolyte membrane 11 to the cathode 17 where the hydrogen ions react with oxygen supplied and electrons (which are generated at an anode of the adjacent MEA and move to the cathode of the instant MEA through a separator, or which are generated at an anode of a fuel cell located at a first end of a fuel cell stack and move to a cathode of a fuel cell located at a second, opposite end of the fuel cell stack through an external electrical circuit) to form water and to generate power according to the following equations:

At the anode: H₂→2H⁺+2e⁻

At the cathode: 2H⁺+2e⁻+(½)O_{2→H}₂O

The electrolyte membrane 11 is made from an ion-exchange membrane including a sulfonic acid group, for example, perfluorocarbon sulfonic acid-type ion-exchange membrane, which causes a proton to move in the electrolyte membrane 11.

The electrodes 14 and 17 which are catalyst layers include Pt—Ru alloy 1 as a catalyst, catalyst carrier (for example, carbon) 2 and electrolyte (preferably, the same material as the electrolyte membrane 11). Ru is included for preventing or suppressing CO-poisoning of Pt and is included in the form of Pt—Ru alloy. A ratio of Pt and Ru is not limited particularly, but preferably, the ratio of Pt and Ru is about (90:10)-(30:70). The diffusion layers 13 and 16 have conductivity, gas passability and water passability and are made from, for example, carbon fibers.

A metal element 50 which is lower in standard potential than Ru and higher in standard potential than hydrogen is contained as follows:

(a) the anode-side diffusion layer 13, or
(b) the anode-side diffusion layer 13 and a catalyst layer portion 14a of the anode-side catalyst layer 14 located apart from the electrolyte membrane 11 (in a case where the catalyst layer 14 is sectioned into a portion 14b contacting the electrolyte membrane 11 and a catalyst portion 14a apart from the electrolyte membrane 11, that catalyst portion 14a apart from the electrolyte membrane 11), or
(c) the catalyst layer portion 14a of the anode-side catalyst layer 14 located apart from the electrolyte membrane 11.

It is preferable that the metal element 50 is contained in the anode-side catalyst layer 14 and the anode-side diffusion layer 13 into which CO is likely to enter. The cathode-side catalyst layer 17 and the cathode-side diffusion layer 16 are not required to contain the metal element 50.

The metal element 50 electrically conducts to Ru via the carbon contained in the diffusion layer 14 and/or the catalyst layer 14.

The metal element 50 is made into the form of fine particles, powders, fine fillers, or fine fibers, etc.

(a) The metal element 50 may be mixed in the anode-side diffusion layer 13 and/or the catalyst layer portion 14a of the catalyst layer 14 apart from the electrolyte membrane 11 (without being carried by the catalyst carrier 2 as illustrated in FIGS. 1 and 3), or
(b) the metal element 50 may be carried by the carbon particles and the carbon fibers of the anode-side catalyst layer 13 or by may be carried by the catalyst carrier 2 (carbon particles and carbon fibers) of the catalyst layer portion 14a of the catalyst layer 14 apart from the electrolyte membrane 11 (FIG. 4).

When mixing the metal element 50 into the catalyst layer 14,

(a) the catalyst layer 14 is made into the form of a single layer, and the metal element 50 may be mixed into the catalyst layer portion 14a of the single catalyst layer apart from the electrolyte membrane 11 (FIG. 1), or
(b) the catalyst layer 14 is made into the form of a double layer including a first catalyst layer portion 14a and a second catalyst layer portion 14b made in different layer and layered to each other, and the metal element 50 may be mixed into the catalyst layer portion 14a apart from the electrolyte membrane 11 only (FIG. 2).

The metal element 50 which is lower in standard potential than Ru and higher in standard potential than hydrogen (which is lower than a standard potential of Ru, 0.46V and higher than a standard potential of hydrogen, 0V; more desirably, lower than 0.46V and higher than 0.10V; and further more desirably, higher than 0.20V, in standard potential) is at least one element selected from the group composed of Cu (copper), Re (rhenium) and Ge (germanium). The metal element 50 is desirably Cu which is highest in standard potential among Cu, Re and Ge.

Standard potentials of Pt, Ru, Cu, Re, Ge and H is 1.32V (volt), 0.46V, 0.337V, 0.30V, 0.247V and 0V (the standard potential of hydrogen is a reference standard potential), respectively.

The reason why it is desirable that the minimum value of the standard potentials of metal elements is to be high is that if the standard potential of the metal element is too low, the metal element is likely to melt out and to be lost, thus, it may be desirable to prevent such an occurrence. The reason why the maximum value of the standard potentials of metal elements is to be lower than 0.46V is that if the standard potential of the metal element is equal to or higher than 0.46V, the metal element will not operate as a sacrificial anode to suppress melting of Ru.

Next, operation and technical advantages common to all embodiments of the present invention will be explained.

Since the metal element 50 which is lower in standard potential than Ru and higher in standard potential than hydrogen is provided, when the anode potential increases significantly due to an excessive rise in the anode voltage, the metal element 50 operates as a sacrificial anode and melts out earlier than Ru to suppress melting of Ru so that suppression of CO-poisoning of Pt by Ru can be maintained. As a result, when reformed gas containing hydrogen is used for the fuel gas, CO-poisoning of Pt can be suppressed so that a sufficient voltage of generated power is obtained for a long period of time.

Further, since the metal element 50 which is lower in standard potential than Ru and higher in standard potential than hydrogen is contained at the anode-side diffusion layer 13 and/or at the catalyst layer portion 14a of the anode-side catalyst layer 14 apart from the electrolyte membrane 11, when the metal element 50 melts out in the form of ions in water (water for humidifying the gas and product water passing through the membrane 11) contacting the catalyst layer 14 and the diffusion layer 13, the metal element ions is unlikely to arrive at the electrolyte membrane 11 because the catalyst layer 14 or the catalyst layer portion 14b is provided, and is unlikely to deteriorate the proton transmitting ability of the electrolyte membrane 11. As a result, both suppression of CO-poisoning of a Pt—Ru catalyst 1 and suppression of metal ion-contamination of an electrolyte membrane 11 can be satisfied.

For an example of the metal element 50 which is lower in standard potential than Ru and higher in standard potential than hydrogen, Cu, Re, or Ge can be raised.

Next, structures, operations and technical advantages unique to each embodiment of the present invention will be explained.

### Embodiment 1

### FIG. 1

In Embodiment 1 of the present invention, as illustrated in FIG. 1, the metal element 50, which is lower in standard potential than Ru and higher in standard potential than hydrogen, for example, Cu, Re or Ge, which is made in the form of fine particles is mixed in the anode-side diffusion layer 13. The fine particles of the metal element 50, for example, Cu, Re or Ge, may not be carried by the carbon particles or carbon fibers of the diffusion layer 13, or, alternatively, may be carried by the carbon particles or carbon fibers of the diffusion layer 13.

The metal element 50, which is lower in standard potential than Ru and higher in standard potential than hydrogen, is not mixed in any of the anode-side catalyst layer 14, the cathode-side diffusion layer 16 and the cathode-side catalyst layer 17.

With respect to operations and technical advantages of Embodiment 1 of the present invention, since the metal element 50 is mixed in the anode-side diffusion layer 13 it may conduct to Pt—Ru catalyst 1 in the anode-side catalyst layer 14 via the carbon in the diffusion layer 13. Thus, when the anode potential rises, the metal element 50 operates as a sacrificial anode and melts out in the form of ions earlier than Ru to suppress melting of Ru of the Pt—Ru catalyst 1. FIG. 1 shows that when Cu is used for the metal element 50, the Cu melts in the form of Cu²⁺. As a result of the suppression of melting of Ru, Ru can suppress CO-poisoning of Pt for long periods of time. Further, the metal element 50 may suppress the Ru from changing to ions and diffusing into the electrolyte membrane 11 so that degradation of the electrolyte membrane 11 by the ions (which obstruct movement of protons) and a decrease in fuel cell performance can be limited and/or prevented. Even if the metal element 50 changes to the form of ions and melts, since the anode-side catalyst layer 14 exists between the anode-side diffusion layer 13 and the electrolyte membrane 11, the ions are unlikely to diffuse into the electrolyte membrane 11 so that degradation of the electrolyte membrane 11 by the ions is unlikely to occur.

### Embodiment 2

### FIGS. 2 and 3

In Embodiment 2 of the present invention, as illustrated in FIGS. 2 and 3, the metal element 50 which is lower in standard potential than Ru and higher in standard potential than hydrogen, for example, Cu, Re or Ge, which is made in the form of fine particles is mixed in the catalyst layer portion 14a (in a case where the catalyst layer 14 is sectioned into the portion 14b contacting the electrolyte membrane 11 and the portion 14a apart from the electrolyte membrane 11, that portion 14a) of the anode-side catalyst layer 14 apart from the electrolyte membrane 11. The fine particles of the metal element 50, for example, Cu, Re or Ge, are mixed only, without being carried by the carbon particles or carbon fibers of the catalyst layer 14. A case where the fine particles of the metal element are carried by the carbon particles or carbon fibers of the catalyst layer 14 will be explained in Embodiment 3. The catalyst layer portions 14a and 14b may be made different from each other and then layered to each other (FIG. 2), or may be formed in a single layer at a portion apart from the electrolyte membrane 11 and at a portion contacting the electrolyte membrane 11.

The metal element 50, which is lower in standard potential than Ru, and higher in standard potential than hydrogen, is not mixed in any of the electrolyte membrane contacting portion 14b of the anode-side catalyst layer 14, the cathode-side diffusion layer 16 and the cathode-side catalyst layer 17. The metal element 50 which is lower in standard potential than Ru and higher in standard potential than hydrogen may be or may not be mixed in the anode-side diffusion layer 13.

With respect to operations and technical advantages of Embodiment 2 of the present invention, since the metal element 50 mixed in the catalyst layer portion 14a of the anode-side catalyst layer 14, apart from the electrolyte membrane 11, conducts to Pt—Ru catalyst 1 in the anode-side catalyst layer 14 via the carbon in the catalyst layer 14, when the anode potential rises, the metal element 50 operates as a sacrificial anode and melts out in the form of ions earlier than Ru to suppress melting of Ru of the Pt—Ru catalyst 1. FIG. 3 shows that when Cu is used for the metal element 50, the Cu melts in the form of Cu²⁺. As a result of the suppression of melting of Ru, Ru can suppress CO-poisoning of Pt for longer periods of time. Further, the metal element 50 suppresses Ru changes to ions and diffuses into the electrolyte membrane 11 so that degradation of the electrolyte membrane 11 by the ions (which obstruct movement of protons) and decrease in the fuel cell performance can be limited or prevented. Even if the metal element 50 changes to the form of ions and melts, since the catalyst layer portion 14b where no metal element is contained exists between the catalyst layer portion 14a and the electrolyte membrane 11, the ions are unlikely to diffuse into the electrolyte membrane 11 so that degradation of the electrolyte membrane 11 by the ions is unlikely to occur.

### Embodiment 3

### FIGS. 2 and 4

In Embodiment 3 of the present invention, as illustrated in FIGS. 2 and 4, the metal element 50 which is lower in standard potential than Ru and higher in standard potential than hydrogen, for example, Cu, Re or Ge which is made in the form of fine particles is contained in the catalyst layer portion 14a (in a case where the catalyst layer 14 is sectioned into the portion 14b contacting the electrolyte membrane 11 and the portion 14a apart from the electrolyte membrane 11, that portion 14a) of the anode-side catalyst layer 14 apart from the electrolyte membrane 11. The fine particles of the metal element 50, for example, Cu, Re or Ge, are carried by the catalyst carrier 2 including the carbon particles or carbon fibers of the catalyst layer 14. A case where the fine particles of the metal element are not carried by the catalyst carrier 2 including the carbon particles or carbon fibers of the catalyst layer 14 has been explained in Embodiment 2. The catalyst layer portions 14a and 14b may be made different from each other and then are layered to each other (FIG. 2), or may be formed in a single layer at a portion apart from the electrolyte membrane 11 and at a portion contacting the electrolyte membrane 11.

The metal element 50 which is lower in standard potential than Ru and higher in standard potential than hydrogen is not contained in any of the electrolyte membrane contacting portion 14b of the anode-side catalyst layer 14, the cathode-side diffusion layer 16 and the cathode-side catalyst layer 17. The metal element 50 which is lower in standard potential than Ru and higher in standard potential than hydrogen may be or may not be contained in the anode-side diffusion layer 13.

With respect to operations and technical advantages of Embodiment 3 of the present invention, since the metal element 50 contained in the catalyst layer portion 14a of the anode-side catalyst layer 14 apart from the electrolyte membrane 11 conducts to Pt—Ru catalyst 1 in the anode-side catalyst layer 14 via the carbon in the catalyst layer 14, when the anode potential rises, the metal element 50 operates as a sacrificial anode and melts out in the form of ions earlier than Ru to suppress melting of Ru of the Pt—Ru catalyst 1. FIG. 4 shows that when Cu is used for the metal element 50, the Cu melts in the form of Cu²⁺. As a result of the suppression of melting of Ru, Ru can suppress CO-poisoning of Pt for a long period of time. Further, the metal element 50 suppresses that Ru changes to ions and diffuses into the electrolyte membrane 11 so that degradation of the electrolyte membrane 11 by the ions (which obstruct movement of protons) and decrease in the fuel cell performance can be suppressed. Even if the metal element 50 changes to the form of ions and melts, since the catalyst layer portion 14b where no metal element is contained exists between the catalyst layer portion 14a and the electrolyte membrane 11, the ions are unlikely to diffuse into the electrolyte membrane 11 so that degradation of the electrolyte membrane 11 by the ions is unlikely to occur. The fuel cell 10 of the present invention is available to a polymer electrolyte fuel cell which is of a low temperature-type fuel cell and which contains the Pt—Ru catalyst 50 for the anode-side catalyst 50.

The fuel cell 10 of the present invention is available to a polymer electrolyte fuel cell which is of a low temperature-type fuel cell and which contains the Pt—Ru catalyst 50 for the anode-side catalyst 50.

The examples described herein are merely illustrative, as numerous other embodiments may be implemented without departing from the spirit and scope of the exemplary embodiments of the present invention. Moreover, while certain features of the invention may be shown on only certain embodiments or configurations, these features may be exchanged, added, and removed from and between the various embodiments or configurations while remaining within the scope of the invention. Likewise, methods described and disclosed may also be performed in various sequences, with some or all of the disclosed steps being performed in a different order than described while still remaining within the spirit and scope of the present invention.

1. A fuel cell, comprising:
an anode-side diffusion layer;
an anode-side catalyst layer;
an electrolyte membrane;
a cathode-side catalyst (17); and
a cathode-side diffusion layer layered in that order,
wherein the anode-side catalyst layer includes Pt—Ru catalyst, and a catalyst layer portion of the anode-side catalyst layer apart from the electrolyte membrane and/or the anode-side diffusion layer contains a metal element which is lower in standard potential than Ru and higher in standard potential than hydrogen, and the metal element which is lower in standard potential than Ru and higher in standard potential than hydrogen is Ge.

2-5. (canceled)

6. A fuel cell according to claim 1, wherein the metal element is mixed in the anode-side catalyst layer and/or the anode-side diffusion layer.

7. A fuel cell according to claim 1, wherein the metal element is carried by a carbon particle or a carbon fiber of the anode-side diffusion layer and/or a catalyst carrier of the anode-side catalyst layer.

8. A fuel cell according to claim 1, wherein the metal element is contained in the anode-side diffusion layer only and is not contained in the anode-side catalyst layer.

9. A fuel cell according to claim 1, wherein the anode-side catalyst layer is a single layer and the metal element is contained in the catalyst layer portion of the anode-side catalyst layer apart from the electrolyte membrane.

10. A fuel cell according to claim 1, wherein the anode-side catalyst layer is a double layer and the metal element is contained in a layer of the double anode-side catalyst layer apart from the electrolyte membrane.

11. A fuel cell according to claim 1, wherein the metal element is not contained in the cathode-side catalyst layer and in the cathode-side diffusion layer.

12. A fuel cell according to claim 1, wherein the metal element electrically conducts to the Ru via carbon of the anode-side diffusion layer and/or of the anode-side catalyst layer.

13. A fuel cell, comprising:
an anode-side diffusion layer;
an anode-side catalyst layer;
an electrolyte membrane;
a cathode-side catalyst; and
a cathode-side diffusion layer layered in that order,
wherein the anode-side catalyst layer includes Pt—Ru catalyst, and the anode-side diffusion layer contains a metal element which is lower in standard potential than Ru and higher in standard potential than hydrogen, and the metal element which is lower in standard potential than Ru and higher in standard potential than hydrogen is at least one element selected from the group composed of Cu and Re.

14. A fuel cell according to claim 13, wherein the metal element is mixed in the anode-side diffusion layer.

15. A fuel cell according to claim 13, wherein the metal element is carried by a carbon particle or a carbon fiber of the anode-side diffusion layer.

16. A fuel cell according to claim 13, wherein the metal element is contained in the anode-side diffusion layer only and is not contained in the anode-side catalyst layer.

17. A fuel cell according to claim 13, wherein the metal element is not contained in the cathode-side catalyst layer and in the cathode-side diffusion layer.

18. A fuel cell according to claim 13, wherein the metal element electrically conducts to the Ru via carbon of the anode-side diffusion layer.
